(19) United States
(12) Patent Application Publication
(10) Pub. No.: US 2007/0042732 A1
(43) Pub. Date: Feb. 22, 2007

(54) Tuner and method for selecting a channel using band-selection filter and broadcast signal receiver including the tuner

(75) Inventors: Hyun-koo Kang, Yongin-si (KR); Jae-young Ryu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/447,041

(22) Filed: Jun. 6, 2006

(30) Foreign Application Priority Data
Aug. 17, 2005 (KR) 10-2005-0075287

(51) Int. Cl. H04B 1/18

(52) U.S. Cl. 455/179.1; 455/188.1

(57) ABSTRACT

A device, system, and method for improving the performance of a tuner for a selected channel by providing a band selection filter controlled by a digital voltage, instead of a notch filter for controlling FM radio signals. The tuner includes a band-selection filter module for selecting a radio frequency RF signal having a frequency within a frequency band of the selected channel using a voltage determined based on digital information; an amplifier module for amplifying the selected RF signal; a mixer module for down-converting the amplified RF signal into a signal having a frequency within an intermediate frequency (IF) band, in which the digital information corresponds to the frequency band of the selected channel.

### CROSS-REFERENCE TO RELATED APPLICATION

This application claims priority from Korean Patent Application No. 10-2005-0075287 filed on Aug. 17, 2005 in the Korean Intellectual Property Office, the disclosure of which is incorporated herein by reference in its entirety.

### BACKGROUND OF THE INVENTION

1. Field of the Invention

The present invention relates to a tuner for a broadcast signal receiver that receives terrestrial/cable broadcast signals, and more particularly, to a method of improving the performance of a tuner for a selected channel by using a band-selection filter controlled by a digital voltage, instead of a notch filter that controls frequency modulation (FM) radio signals.

2. Description of the Related Art

Recent advancements in telecommunication technology have made it possible to watch digital broadcasts through a satellite, terrestrial or cable television (TV) at home. In order to watch the digital broadcasts, a separate network interface module is needed in each TV set. However, with further innovations within the field, digital broadcast signals from terrestrial broadcasts and cable broadcasts can now be received through a single network interface module.

Generally, it is well known that, as a radio frequency (RF) component, a typical tuner selectively tunes into different radio frequencies of terrestrial broadcast signals and plays an essential role in the network interface modules. Inside the tuner, there are various types of filters such as a bandpass filter or a high-pass filter provided at the input end of the tuner, and a low-noise amplifier which amplifies signals output from the filter while drastically reducing noise. Under this structure, FM radio frequency band (88 MHz-108 MHz) is ranged well within the terrestrial/cable broadcast frequency band (54 MHz-860 MHz) for receiving terrestrial/cable broadcasts. As such, a notch filter is used to control or attenuate the FM radio frequencies at the front or rear stage of the low-noise amplifier, thereby preventing deterioration in performance.

FIG. 1 is a block diagram showing the structure of a tuner 120 according to the related art. A high-pass filter 122 filters signals having low frequencies below 45 MHz from signals received through an antenna 100 and passes signals having frequencies in the range of terrestrial/cable broadcast frequency band (54 MHz˜860 MHz).

An FM notch filter 124 then filters the FM radio frequency band (88 MHz˜108 MHz) from the signals passed through the high-pass filter 122. Here, the FM notch filter 124 processes terrestrial broadcast (NTSC/ATSC) signals, but not cable broadcast signals.

A low-noise amplifier 126 amplifies the signals from the FM notch filter 124 and reduces noise. The signals amplified by the low-noise amplifier 126 are attenuated by an attenuator 128 and are tuned by a first channel-selection filter 130. The first channel-selection filter 130 tunes the signals passed through the attenuator 128 using an analog voltage, in order to select a channel and reject image frequencies. The first channel-selection filter 130 selects a channel based on the channel information transmitted from a demodulator (not shown). Here, the first channel-selection filter 130 functions as a channel-selection bandpass filter by generating a resonance frequency corresponding to a channel using an inductor and a variable capacitor according to a predetermined voltage.

VHF/UHF RF auto-gain control (AGC) amplifiers 132 and 136 control and amplify the input RF signal. Second and third channel-selection filters 134 and 138 select corresponding channels and reinforce the image frequency rejection. The VHF RF signal or UHF RF signal passing through the tuner 120 is down-converted into an intermediate frequency by a VHF down-mixer 140 or a UHF down-mixer 150. In this case, depending on whether the signal having passed through the first channel-selection filter 130 is a VHF signal or a UHF signal, the AGC amplifiers 132 and 136 are powered on or off and operate in suitable frequencies. That is, in the case a VHF signal is input, power supplied to the UHF RF AGC amplifier 136 is shut-off and power is supplied only to the VHF RF AGC amplifier 132, thereby amplifying the VHF signal.

FIG. 2 is a block diagram showing the structure of another tuner 220 according to the related art. An RF tuning filter 222 receives RF signals received through an antenna, selects a specific channel and rejects image frequencies. For these operations, the RF tuning filter 222 includes a bandpass filter supplied with an analogue voltage.

A variable low-noise amplifier 224 amplifies signals having frequencies that falls within the terrestrial/cable broadcast infrequency band (54 MHz˜860 MHz) from the input RF signals and reduces noise. A notch filter 226 filters or attenuates signals in the FM radio frequency band (88 MHz˜108 MHz) from the RF signals having passed through the variable low-noise amplifier 224. Also, in this case, the notch filter 226 processes terrestrial broadcast (NTSC/ATSC) signals, but not cable broadcast signals.

A mixer 240 generates an intermediate frequency by mixing the RF signals having passed through the notch filter 226 and a signal supplied by a voltage controlled oscillator (VCO) 230.

Referring to the structure of the tuners shown in FIGS. 1 and 2, the tuning operation is implemented by a varactor using an analog voltage. Specifically, the tuner can be tuned to various frequencies by making one side or both sides of a coil and a condenser variable or by making the inductance of the coil and the capacitance of the condenser changeable.

When the tuner is controlled by using an analogue voltage, it is difficult to select a frequency band near 6 MHz, relative to the terrestrial/cable broadcast frequency band (54 MHz˜860 MHz), which causes the image rejection ratio to be changed, thereby resulting in deterioration in performance of a specific channel.

In addition, when a notch filter is used to suppress RF signals, it also affects signals having frequencies adjacent to the suppressed radio frequency band, causing not only deterioration in performance but also deterioration in the reception sensitivity because of the increasing noise figure.

### SUMMARY OF THE INVENTION

The present invention provides a method of improving the performance of a tuner for a selected channel by providing a band-selection filter controlled by a digital voltage, instead of a notch filter for controlling FM radio signals.

According to an aspect of the present invention, there is provided a tuner including a band-selection filter module for selecting an RF signal having a frequency within a frequency band of a selected channel, using a voltage determined based on digital information from the RF signal; an amplifier module for amplifying the selected RF signal; and a mixer module for down-converting the amplified RF signal into an RF signal having a frequency within an intermediate frequency (IF) band, in which the digital information corresponds to the frequency band of the selected channel.

According to another aspect of the present invention, there is provided a broadcast signal receiver including a tuner for down-converting RF signals having frequencies within a frequency band of a selected channel into intermediate frequency (IF) signals, using a voltage determined based on digital information from the RF signals received through an antenna; an IF channel-selection filter for selecting an IF signal having a frequency within the frequency band of the selected channel from the IF signals; an IF amplifier for amplifying the selected IF signal; an IF down-mixer for down-converting the amplified IF signal into a baseband signal; and a baseband-signal module for processing the baseband signal and providing information on the selected channel to the tuner, in which the digital information corresponds to the frequency band of the selected channel.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram showing the structure of a related art tuner.

FIG. 2 is a block diagram showing the structure of another related art tuner.

FIG. 3 is a block diagram showing the structure of a broadcast signal receiving apparatus according to an exemplary embodiment of the present invention.

FIG. 4 is a block diagram showing the structure of a tuner according to an exemplary embodiment of the present invention;

FIG. 5 is a block diagram showing the structure of a band-selection control module according to an exemplary embodiment of the present invention; and

FIGS. 6A to 6F show an example of a look-up table stored in a storage module of a tuner according to an exemplary embodiment of the present invention.

### DETAILED DESCRIPTION OF THE EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

A tuner and a broadcast signal receiver including the tuner according to an exemplary embodiment of the present invention will now be described more fully with reference to the accompanying drawings.

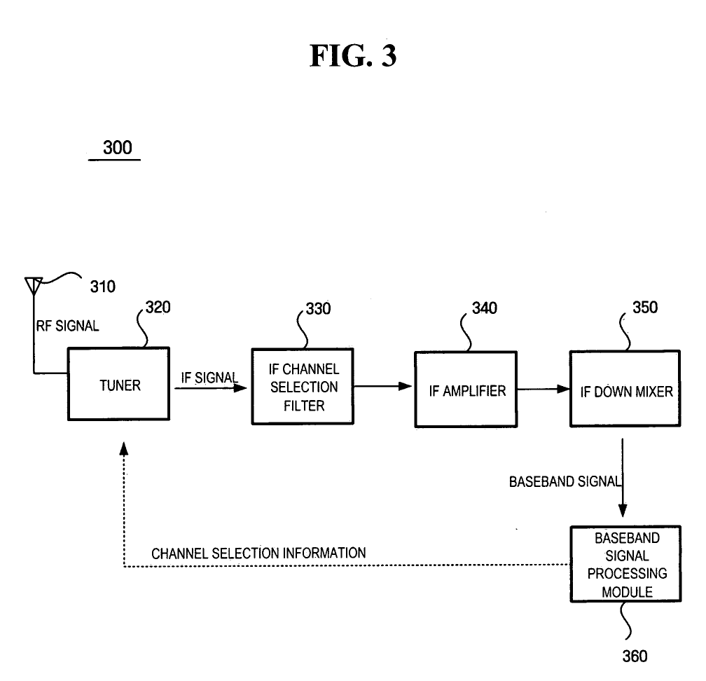

FIG. 3 is a block diagram showing the structure of a broadcast signal receiving apparatus according to an exemplary embodiment of the present invention.

Referring to FIG. 3, a broadcast signal receiving apparatus 300 includes an antenna 310, a tuner 320, an intermediate frequency (IF) channel-selection filter 330, an IF amplifier 340, an IF down-mixer 350 and a baseband-signal processing module 360. Each of the IF channel-selection filter 330, the IF amplifier 340 and the IF down-mixer 350 process IF signals, and may collectively be referred to as “an IF signal processing unit”.

The antenna 310 receives and converts RF signals into electrical signals.

Based on channel-selection information on a selected channel, the tuner 320 down-converts the RF signals received through the antenna 310 into IF signals. Here, the tuner 320 down-converts only RF signals belonging to a frequency band corresponding to the selected channel into IF signals.

The IF channel-selection filter 330 filters or attenuates IF signals belonging to frequency bands of the other channels except for the selected channel, and the IF amplifier 340 amplifies the IF signals corresponding to the selected channel. With respect to current terrestrial/cable broadcast services, a bandwidth of the selected channel is preferably about 6 MHz. The IF amplifier 340 may function as a variable-gain amplifier or auto-gain controller in order to control the gain, when an accurate power control is needed.

The IF down-mixer 350 down-converts the selected IF signal into a baseband signal having a low frequency of its corresponding original signal. The IF down-mixer 350 may include an IF local oscillator for providing a local oscillating frequency.

The baseband-signal processing module 360 processes the baseband signal provided by the IF down-mixer 350. The baseband-signal processing module 360 may include a demodulator for demodulating the baseband signal and transmitting the information on the selected channel to the tuner 320. The tuner 320 generates a voltage for the channel selection using digital information corresponding to the channel-selection information on the selected channel, whereby only RF signals belonging to the frequency band of the selected channel are converted into IF signals.

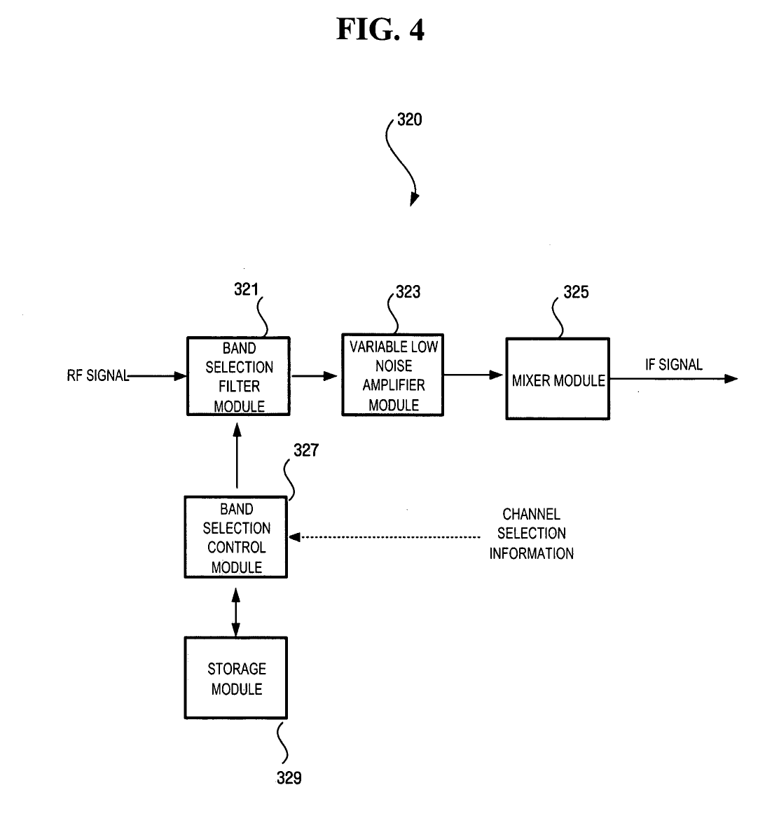

FIG. 4 is a block diagram showing the structure of a tuner according to an exemplary embodiment of the present invention.

Referring to FIG. 4, the tuner 320 includes a band-selection filter module 321, a variable low-noise amplification module 323, a mixer module 325, a band-selection control module 327, and a storage module 329.

The term ‘module’, as used herein, means, but is not limited to, a software or hardware component such as a field-programmable gate array (FPGA) or application-specific integrated circuit (ASIC) for performing certain tasks. A module may advantageously be configured to reside on an addressable storage medium and configured to be executed on one or more processors. Thus, the module may include, by way of example, components such as software components, object-oriented software components, class components and task components, processes, functions, attributes, procedures, subroutines, segments of program code, drivers, firmware, microcode, circuitry, data, databases, data structures, tables, arrays, and variables. The functionality provided in the components and modules may be combined into fewer components and modules, or further separated into additional components and modules.

As the respective modules illustrated in FIG. 4 are integrated into a single circuit, that is, an integrated circuit, the tuner 320 may be provided as a single semiconductor chip or a semiconductor package.

The RF signals received through the antenna 310 are comprised of various frequencies. Thus, a band-selection filter module 321 performs bandpass filtering to select only the signals in the frequency band of the selected channel. That is, the band-selection filter module 321 allows only the signals in the frequency band of the selected channel to pass, unlike the conventional art which allows signals in the frequency band of all channels to be passed (except for those in the FM radio band).

When the tuner 320 is a can-type, the band-selection filter module 321 may be constructed using a passive component. When the tuner 320 is an integrated circuit, the band-selection filter module 321 may be constructed using an active component.

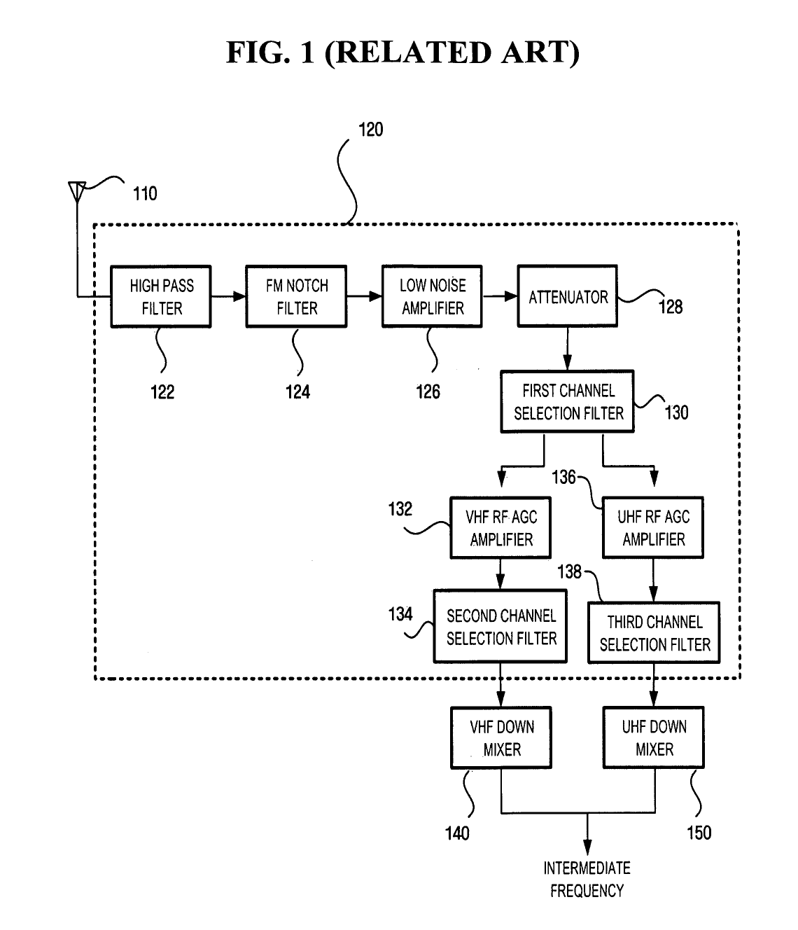

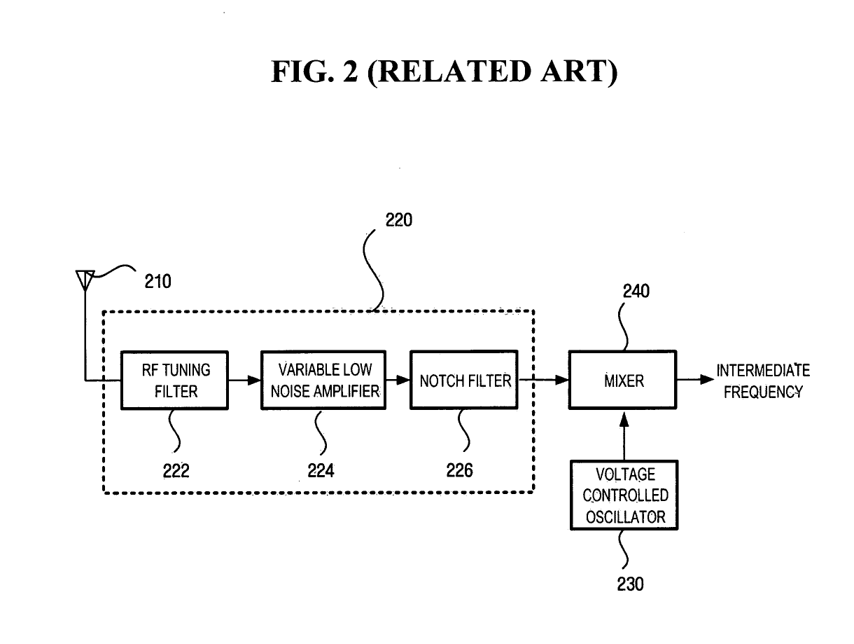

The band-selection filter module 321 selects only the channel specified by the band-selection control module 327. Referring to FIG. 1, the band-selection control module 327 receives channel-selection information selected by a user through the baseband-signal processing module 360, and extracts digital information corresponding to the channel-selection information from the storage module 329.

The storage module 329 stores respective frequency bands for terrestrial broadcasts and cable broadcasts, channel numbers and control bits corresponding to the frequency bands in the form of a look-up table, using a nonvolatile memory device. All channels for the terrestrial and cable broadcasts can be represented using eight bits as the control bits. The control bits, however, are not limited to eight bits, but may be represented with any number of bits.

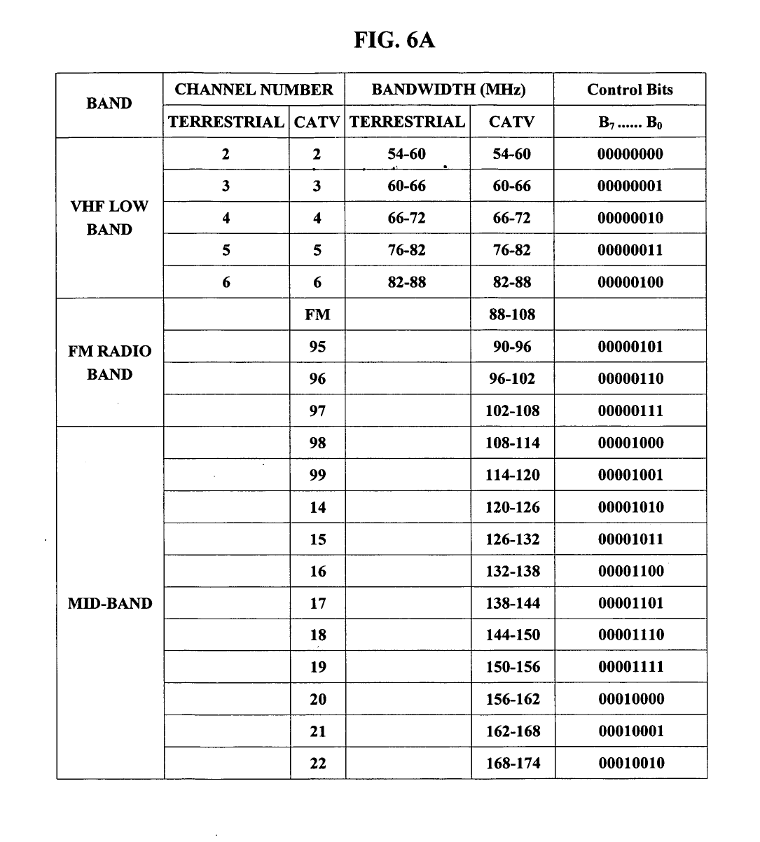

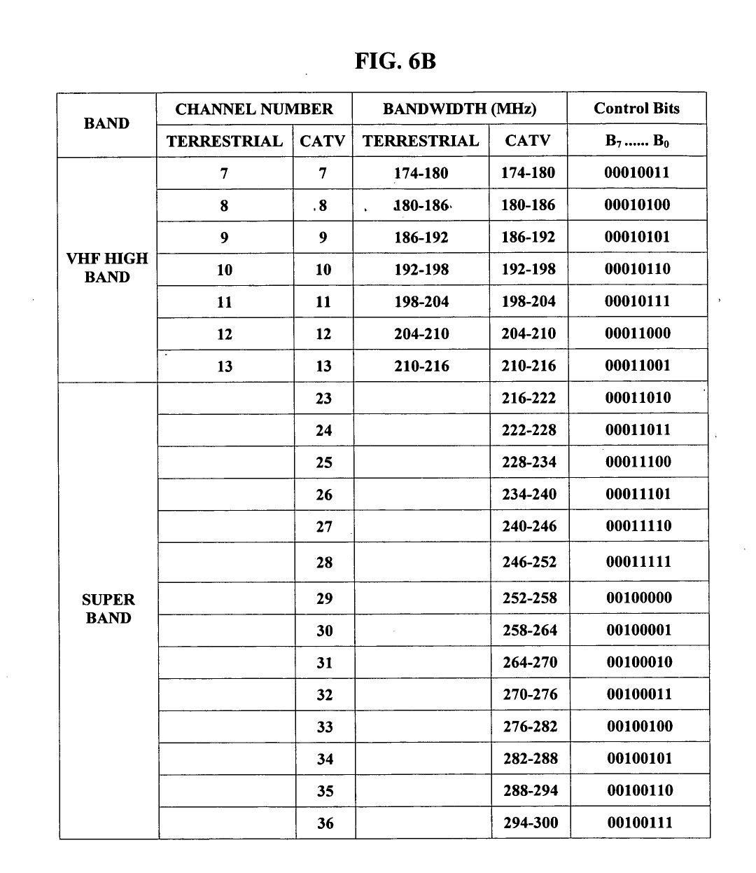

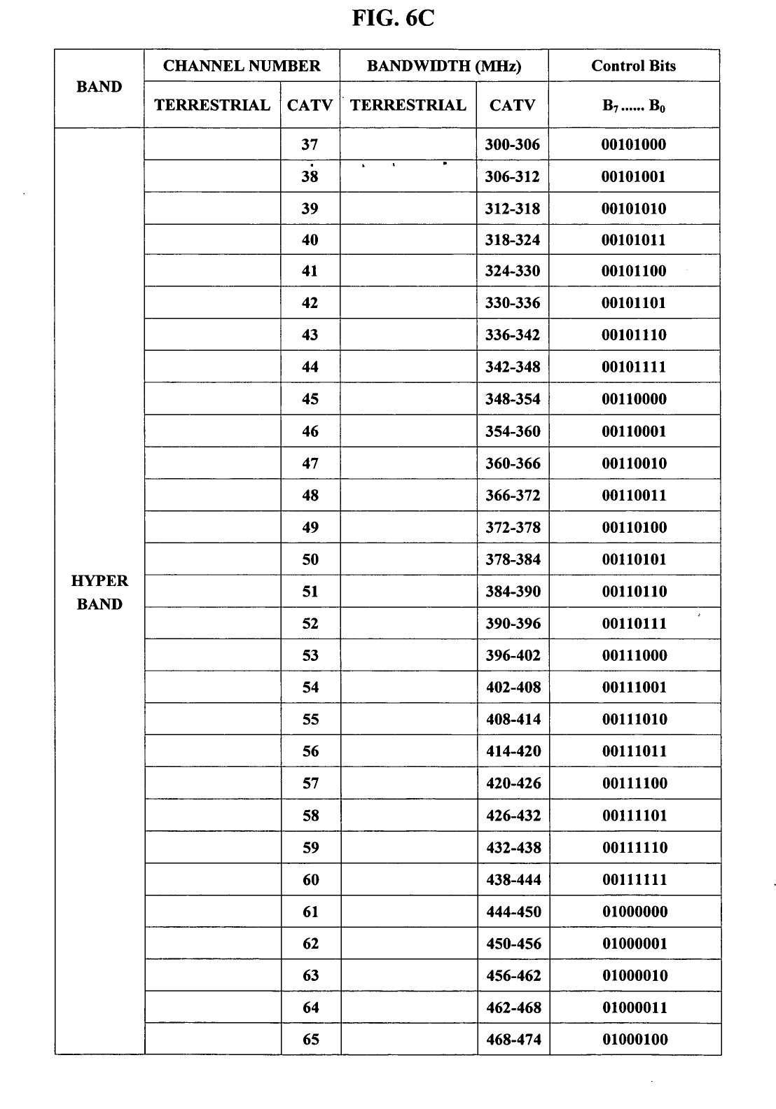

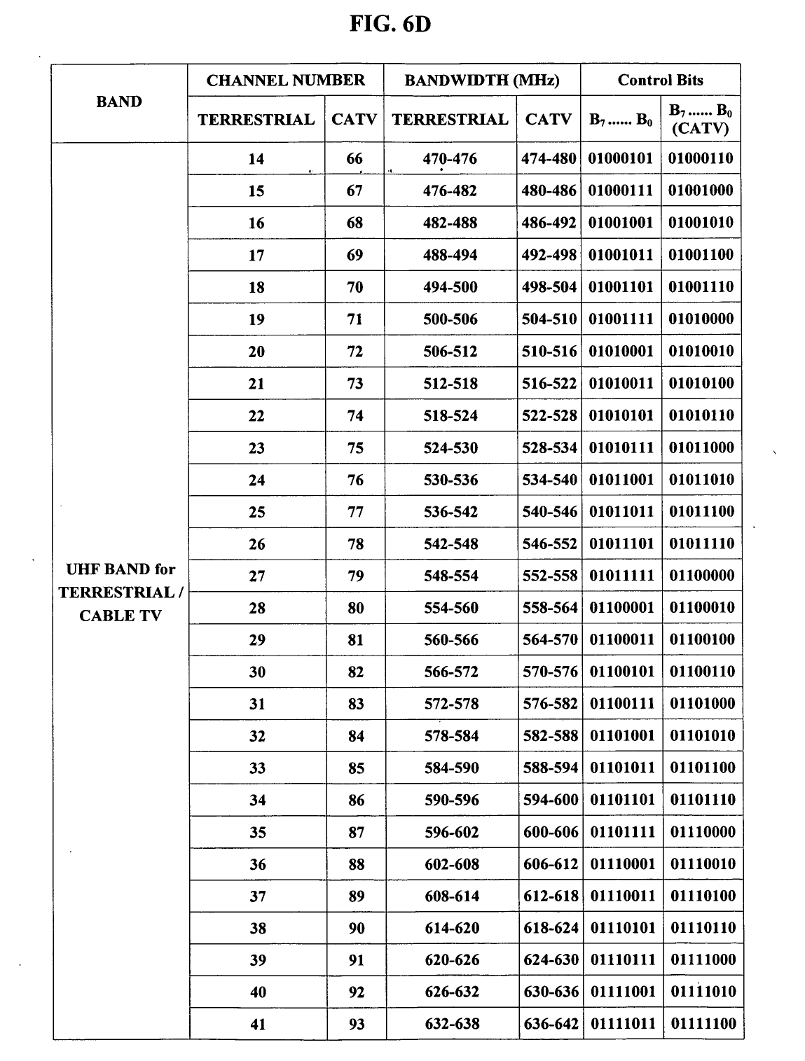

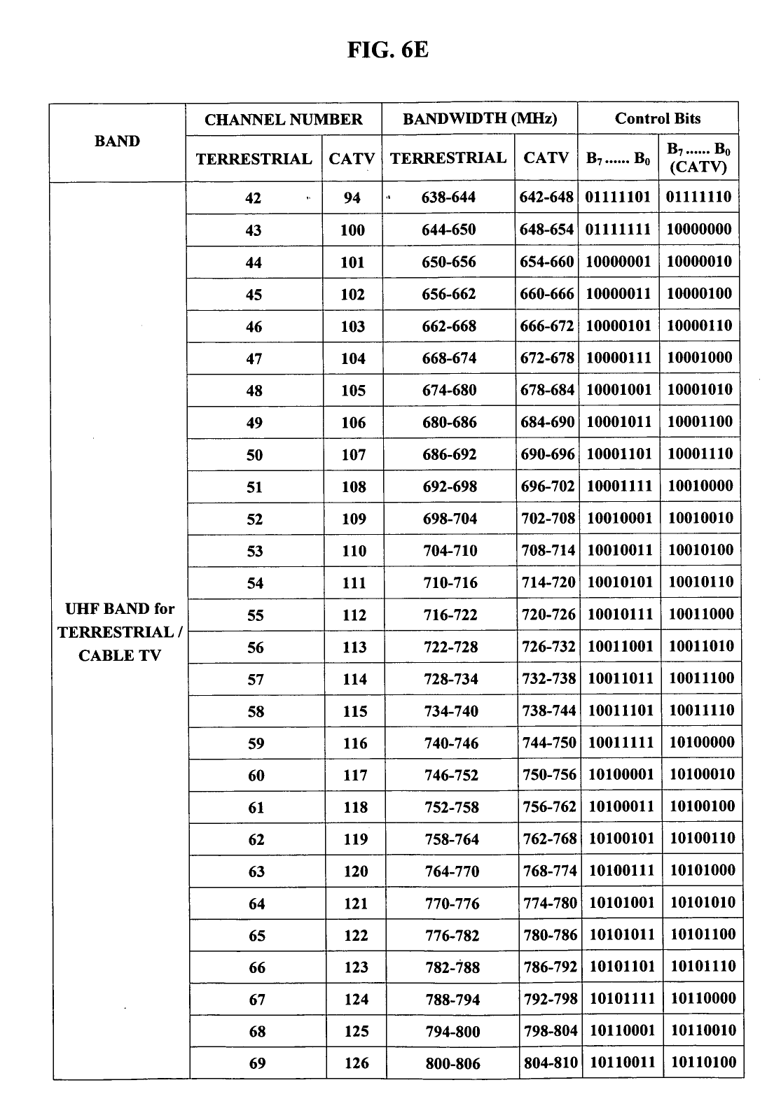

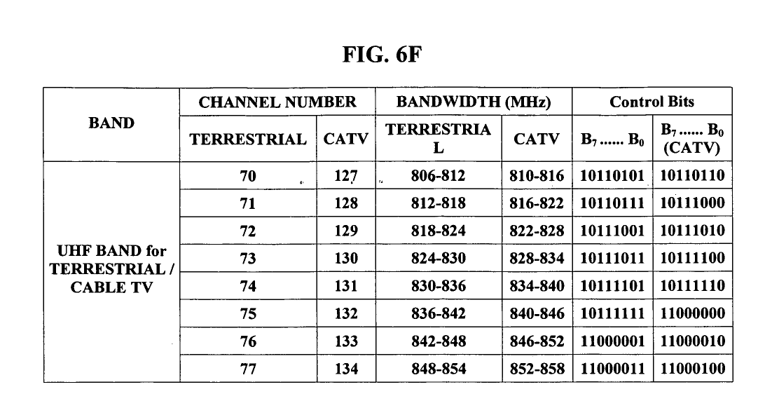

FIGS. 6A to 6F show an example of the look-up table stored in the storage module 329.

The band-selection control module 327 extracts the digital information, that is, control bits corresponding to the channel-selection information from the storage module 329 and provides a voltage generated according to the extracted control bits to the band-selection filter module 321.

The band-selection filter module 321 allows only the signal in the frequency band of the selected channel to pass, using the voltage provided from the band selection control module 327.

Since only the channel specified by the digital information is selected, there is no need to implement a notch filter for controlling FM radio signals as in the conventional art. Further, the image rejection ratio can be increased by controlling image frequencies.

The variable low-noise amplifier module 323 amplifies the RF signal passed from the band-selection filter module 321 while optimally suppressing the amplification of noise. At this time, it is also possible to control gain.

The mixer module 325 down-converts the amplified RF signal by the variable low-noise amplification module 323 into a signal of an intermediate frequency (IF) band. In this case, the mixer module 325 may use an image rejection down-mixer in order to increase the image rejection ratio.

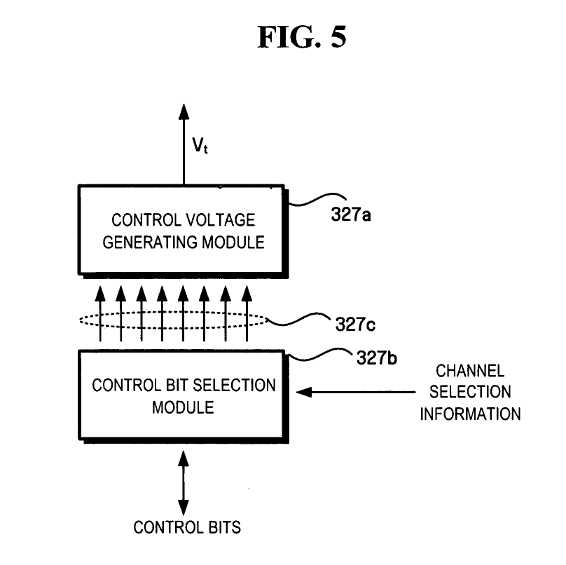

FIG. 5 is a block diagram showing an example of the structure of a band-selection control module 327 including a control-voltage generating module 327a and a control-bit selection module 327b.

The control-bit selection module 327b extracts control bits corresponding to the channel-selection information from the storage module 329 and provides the extracted control bits to the control-voltage generating module 327a.

As an exemplary embodiment, FIG. 5 shows that the control-bit selection module 327B provides control bits 327c comprised of eight bits to the control-voltage generating module 327a.

Based on the control bits received from the control-bit selection module 327b, the control-voltage generating module 327a generates a voltage for selecting a frequency band corresponding to the selected channel.

Specifically, the control-voltage generating module 327a may generate a voltage having a predetermined magnitude through a resistance, by controlling the flow of current according to an on or off operation for each control bit. The voltage is provided to the band-selection filter module 321 to control a pass band.

For example, when the band-selection filter module 321 includes a varactor, the generated voltage is provided to an input of the varactor to control the pass band by adjusting the capacitance thereof. When the band-selection filter module 321 is constructed with an active device, it selects the pass band by adjusting two cut-off frequencies, that is, an upper cut-off frequency and a lower cut-off frequency, using the generated voltage.

As described above, the present invention has an advantage in that the performance of a terrestrial/cable broadcast signal receiver can be improved for a selected channel.

In concluding the detailed description, those skilled in the art will appreciate that many variations and modifications can be made to the preferred embodiments without substantially departing from the principles of the present invention. Therefore, the disclosed exemplary embodiments of the invention are used in a generic and descriptive sense only and not for purposes of limitation.

What is claimed is:

1. A tuner comprising:
a band-selection filter module which selects a radio frequency (RF) signal having a frequency within a frequency band of a selected channel, using a voltage determined based on digital information from the RF signal;
an amplifier module which amplifies the selected RF signal; and
a mixer module which down-converts the amplified RF signal into a signal having a frequency within an intermediate frequency (IF) band,
wherein the digital information corresponds to the frequency band of the selected channel.

2. The tuner of claim 1, further comprising:
a storage module which stores channel information, the digital information and the frequency band corresponding to the digital information; and
a band-selection control module which selects digital information corresponding to the selected channel from the storage module and generates the voltage using the selected digital information.

3. The tuner of claim 2, wherein the band-selection control module comprises:
a control-bit selection module which selects the digital information corresponding to the selected channel from the storage module; and
a control-voltage generating module which generates the voltage according to an on or off operation based on the selected digital information.

4. The tuner of claim 1, wherein the digital information includes eight-bit data.

5. The tuner of claim 1, wherein the RF signal is a terrestrial digital-broadcast signal or a cable digital-broadcast signal.

6. The tuner of claim 1, wherein the band-selection filter module, the amplifier module and the mixer module are integrated into an integrated circuit and provided in a form of a semiconductor chip.

7. A broadcast signal receiver comprising:
a tuner which down-converts radio frequency (RF) signals having frequencies within a frequency band of a selected channel into intermediate frequency (IF) signals, using a voltage determined based on digital information from the RF signals received through an antenna;
an intermediate frequency (IF) channel-selection filter which selects an IF signal having a frequency within the frequency band of the selected channel from the IF signals;
an IF amplifier which amplifies the selected IF signal;
an IF down-mixer which down-converts the amplified IF signal into a baseband signal; and
a baseband-signal module which processes the baseband signal and provides information on the selected channel to the tuner,
wherein the digital information corresponds to the frequency band of the selected channel.

8. The receiver of claim 7, wherein the tuner comprises:
a band-selection filter module which selects a radio frequency (RF) signal having a frequency within the frequency band of the selected channel using the voltage determined based on the digital information included in the RF signals received through the antenna;
an amplifier module which amplifies the selected RF signal; and
a mixer module which down-converts the amplified RF signal into a signal having a frequency within an intermediate frequency (IF) band.

9. The receiver of claim 8, wherein the tuner further comprises:
a storage module which stores channel information, the digital information and the frequency band corresponding to the digital information; and
a band-selection control module which selects the digital information corresponding to the selected channel from the storage module and generates the voltage using the selected digital information.

10. The receiver of claim 9, wherein the band-selection control module comprises:
a control-bit selection module which selects the digital information corresponding to the selected channel from the storage module; and
a control-voltage generating module which generates the voltage according to an on or off operation based on the selected digital information.

11. The receiver of claim 7, wherein the digital information includes eight-bit data.

12. The receiver of claim 7, wherein the RF broadcast signal is a terrestrial digital-broadcast signal or a cable digital-broadcast signal.

13. The receiver of claim 7, wherein the tuner is integrated into an integrated circuit and provided in a form of a semiconductor chip.

14. A method of tuning a channel, the method comprising:
selecting a radio frequency (RF) signal having a frequency within a frequency band of a selected channel, using a band-selection filter module which is controlled by a voltage determined based on digital information from the RF signal;
amplifying the selected RF signal; and
down-converting the amplified RF signal into a signal having a frequency within an intermediate frequency (IF) band,
wherein the digital information corresponds to the frequency band of the selected channel.

15. The method of claim 14, further comprising:
storing channel information, the digital information and the frequency band corresponding to the digital information in a storage module; and
selecting digital information corresponding to the selected channel from the storage module and generating the voltage using the selected digital information.

16. The method of claim 15, wherein the digital information includes eight-bit data.

17. The method of claim 14, wherein the RF signal is a terrestrial digital-broadcast signal or a cable digital-broadcast signal.
